(19) United States
(12) Patent Application Publication
(10) Pub. No.: US 2018/0374106 A1
(43) Pub. Date: Dec. 27, 2018

(54) SYSTEM FOR ESTABLISHING IDEAL EXPERIENCE FRAMEWORK

(71) Applicant: Lextant Corporation, Columbus, OH (US)

(72) Inventors: Chris Rockwell, Columbus, OH (US); Spencer Murrell, Columbus, OH (US); Marty Gage, Columbus, OH (US)

(21) Appl. No.: 16/015,022

(22) Filed: Jun. 21, 2018

Related U.S. Application Data
(60) Provisional application No. 62/523,077, filed on Jun. 21, 2017.

(51) Int. Cl. G06Q 30/02; G06Q 10/04

(52) U.S. Cl. CPC G06Q 30/0201; G06Q 10/04

(57) ABSTRACT

The present invention is a system for producing a product experience optimization framework. Once the objective and scope have been identified, embodiments of the invention perform a series of panel activities that extract expressions of desired feelings and the attributes that trigger those feelings with regard to a product. These desired feelings and the corresponding triggers may be used to evaluate products or services, competing products or services, or prototype products or services in order to determine whether those products or services have characteristics that result in the desired feelings in a potential consumer.

### CROSS-REFERENCE TO RELATED APPLICATION

This application is a non-provisional patent application and claims priority to U.S. provisional application 62/523,077, filed Jun. 21, 2017, the contents of which are incorporated by reference as if fully recited herein.

### TECHNICAL FIELD

Exemplary embodiments of the present invention relate generally to a system for providing a framework to determine product or service features that trigger favorable emotional responses in those individuals using the product or service.

### BACKGROUND AND SUMMARY OF THE INVENTION

New or improved product releases are key to the success of businesses. In order to maintain market share, a business offering products or services must continue to offer new and improved products or services. Depending upon the product or service type, the introduction of new products may be required to be performed with relative regularity.

In the current market environment for most products, product quality is a given. Product quality has been improving steadily since the mid-1980's when various quality enhancement programs were instituted by manufacturers. Those manufacturers that didn't implement quality programs rapidly lost market share. Prior to that time, a high-quality product was a selling point that could differentiate one manufacturer or service provider from its competitors. Generally, these higher quality products were more expensive than lower quality alternatives. However, consumers would often see the benefit of the higher quality products despite the higher price. As the result of various quality control efforts such as Six Sigma and Kaizen, the quality gap between high quality, high price products and good quality but lower priced products has narrowed. Currently, a consumer can select from a wide variety of high quality and reasonably priced products. Desirable product features and attributes are required.

The product space beyond quality is that of product features and usability. In order to justify a higher price or to gain market share from competitors, a product or service offering must have features that set that product or service apart from other offerings; such a product must also be user friendly. That is, it must be at least somewhat intuitive in its operation so as to facilitate a user's understanding of how to use the product. As such, manufacturers wishing to offer higher priced products or to gain market share in the more moderate product price categories must look beyond having a high-quality product. But there is still an area of product characteristics that goes beyond even features and usability. That area is the emotions that are triggered when a consumer considers or interacts with a product or service. The emotional response triggered by a product can have a tremendous impact on the thought process of a potential buyer. These emotions ideally result in an increased desire to own or utilize a product or service. For example, buyers of a certain type of luxury product may wish to feel an extra level of safety or perceived ease of use for a particular product. These perceptions may result of certain characteristics of the product even if, in actuality, the product is no more safe or easy to use than a competing product. The materials selected, the characteristics of the controls, the look, the feel, and in some cases, even the smell of the product may be critical. Manufacturers must analyze and understand their customer's desires in order to offer products that provide the attributes that result in a customer desiring to own or utilize the manufacture's products or services. In other words, a clear understanding of the opportunity provided by or the problem that is solved by the product is needed. A company that expends development resources on a product that is not accepted by consumers because of the consumer's perception of the product or service may lose market share to other products or services which have more desirable product attributes. In addition to costing market share, offering a product that doesn't inspire a favorable emotional response may damage the reputation of the company offering the product or service such that later products or services may have difficulty recovering the lost market share, even if those later products have more desirable features than competing products. Therefore, designing for a customer's desired experience is required to be successful.

At the same time that manufacturing process improvements were improving product quality, product production and prototyping technologies were evolving. These new technologies allowed for rapid prototyping of new designs and equally rapid production configuration capabilities. The result of these changes is that new product offerings are much more rapid than they have been in the past. Where new products and features could be developed and introduced gradually and deliberately in the past, the current market requires a product or service company to continuously introduce new products and features in order to remain competitive in the marketplace.

Despite the relative ease of prototyping and manufacturing new products or new product features, these efforts are still costly and consume valuable engineering resources. As such, a manufacturer or service provider cannot afford to introduce products without a significant understanding of how their customers may perceive these products. The introduction of a product that does not result in a favorable emotional response may require as much time and resources as a product which generates a more favorable response. In addition, those competitors manufacturing similar products very likely have the same rapid prototyping capability and also will be working to introduce new and improved products. As a result, expending resources and time developing new products with less than optimal emotional impact on potential consumers may result in an organization developing products that are less optimal than their competitors. In addition to the cost involved, these products may be less able to compete in the marketplace and may result in less revenue to invest in the next product iteration. As a result, the organization's product offerings could remain stagnant while competing products continue to gain market share. As can easily be understood, the result could be a slow death spiral of lost market share for those companies that fail to understand and provide those product benefits desired by their customers.

Thus, the need for quality is presumed and product offerings have evolved to the point where a plethora of novel features are required for a product to compete against other available products and those features must function with overall characteristics of the product in order to satisfy the buyer's emotional needs with regard to the product. These features must be well thought-out and targeted to appeal to the customer. Finally, despite the fact that rapid prototyping technologies are readily available, the cost to develop and produce such new products remains high. As a result, the market for a product or service is generally competitive enough that missteps in terms of product features can be costly.

What is needed is a means to ideate and package an offer to increase acceptability, adoption, and experience by a customer of a product or service.

The present invention comprises a system to determine which product features of a pre-selected good or service are most important for consumers shopping for that good or service, and to identify with particularity what about those features generates such importance. In an embodiment of the invention, a framework is developed to identify which perceptions of a product are most important for a consumer or buyer of the product. This framework is then applied to potential consumers to receive feedback from those potential consumers in order to identify an ideal product experience. Projective stimulus is provided to a panel of potential customers in order to evoke expressions relative to the product being evaluated. The potential customers are interviewed and asked what caused them to select a stimulus when thinking about a product feature. These results are automatically processed and analyzed to identify recurring expressions that represent product attributes, which are related to product features and benefits and ultimately invoke the desired emotional benefit flowing from the brand promise. A report is generated with the system results.

Further features and advantages of the devices and systems disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a graphical representation between the emotions that a consumer wishes to experience and the sensory cues of a product or service that ultimately result in those emotions;

FIG. 2 is a representation of an ideal product experience diagram;

FIG. 3 is a flow chart illustrating the high-level steps performed by an embodiment of the invention;

FIG. 4 is a diagram illustrating the high-level steps used to develop an ideal experience framework and the use of such a framework in later benchmark evaluations;

FIGS. 5A and 5B are a flow chart providing a more detailed illustration of the step performed when building a research driven framework and conducting the research;

FIG. 6 is a flow chart illustrating the steps performed to normalize and assign codes to data collected from panel participants; and

FIGS. 7-13 provide further self-explained pictorial views of an exemplary embodiment of the present invention.

### DETAILED DESCRIPTION OF EXEMPLARY EMBODIMENTS

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

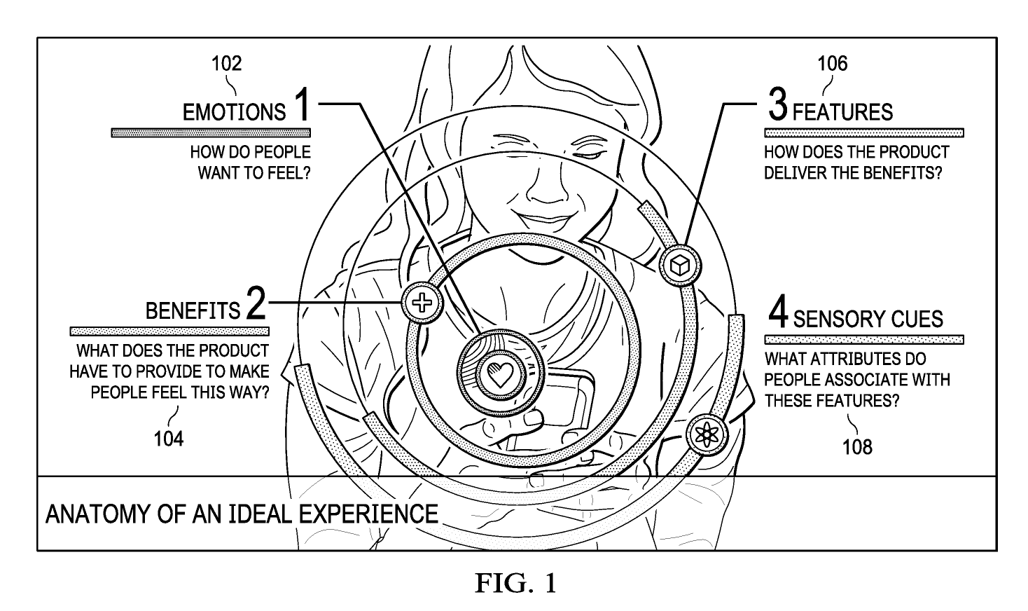

An ideal product experience can be visualized as an interconnected framework of insights that connect key emotions to specific design attributes. FIG. 1 illustrates a graphical representation of an ideal product or service experience as identified using the framework described herein. As illustrated, the emotions 102 that result from interactions with the product or service are central to the concept of the ideal experience. This could also be thought of as the brand promise. In other words, what do consumers want to feel when considering the product or service? As described herein, identifying how a consumer wants to feel is key to creating the deal experience in a product or service. Once the desired emotions are identified, product benefits 104 that result in the desired emotions may be determined. These benefits are what is provided by the product that result in the emotions defining the ideal product experience. Benefits are generally provided by product features 106. Features might include certain ways that a product might interact with a consumer; for example, the ability to customize a user interface or a particular product function. Finally, there may be certain attributes that are associated with the product features. These may be referred to as sensory cues 108. Examples of sensory cues might be the shape or feel of a control.

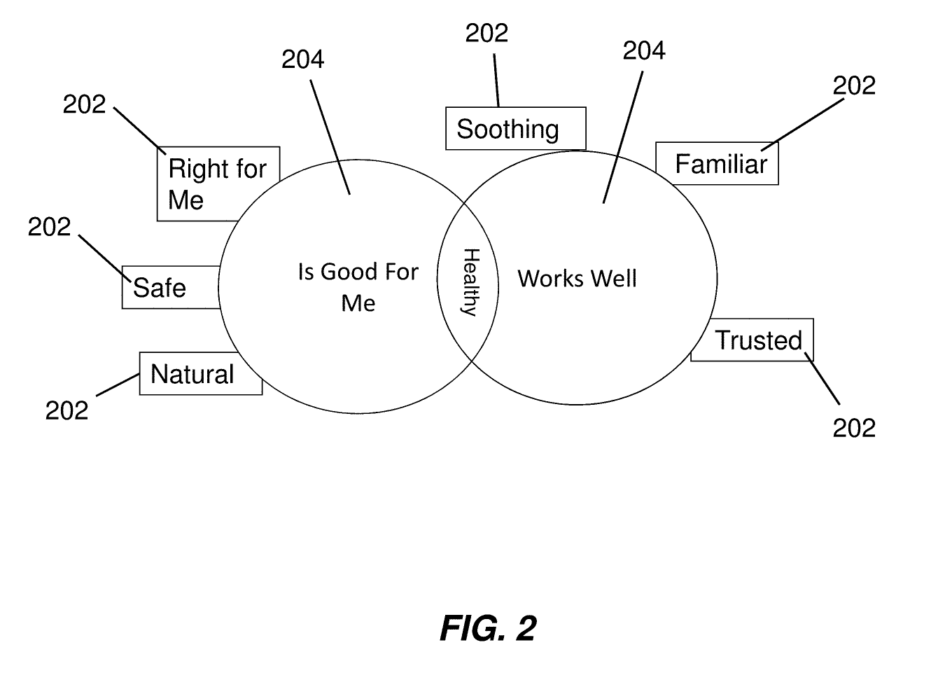

As is shown in the ideal experience framework diagram illustrated in FIG. 2, the feature 202 and benefits 204 can be presented in a graphical format that illustrates the interrelationships between the features and benefits and also the emotions or feelings that are associated with these features and benefits.

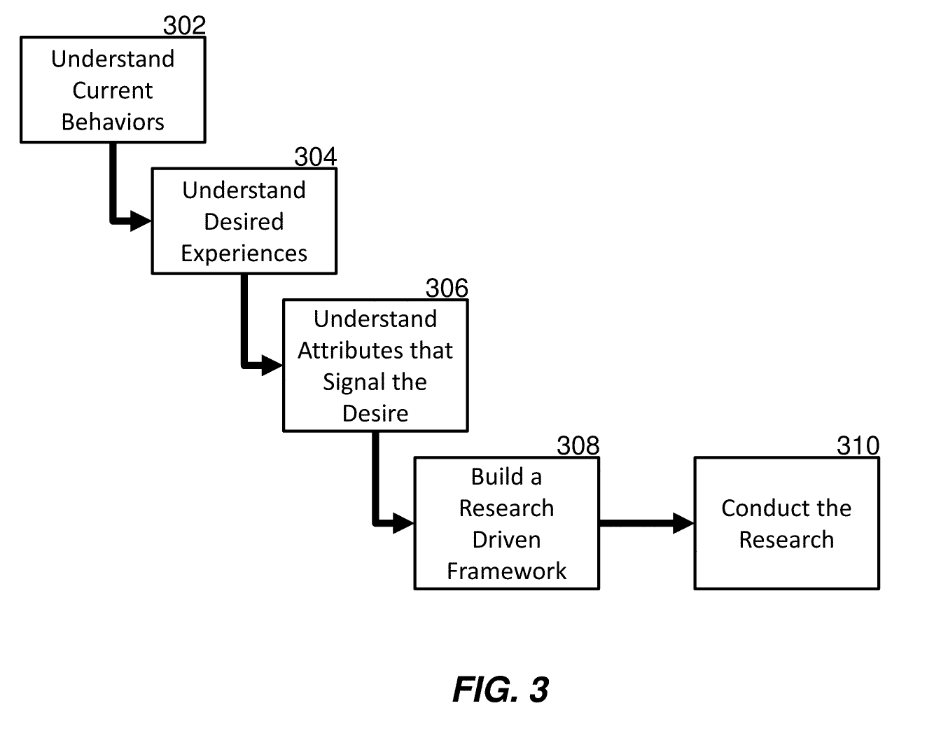

FIG. 3 illustrates a flow chart with the steps that may be performed when implementing the invention. Step 302 is the process of understanding a consumer's current behaviors. These behaviors help to identify the consumer's expectations of the product or service experience generally. These could be thought of as baseline behaviors. Step 304 is the understanding of the consumer's desired experiences. This was illustrated in FIG. 1 at 102. Step 306 involves the understanding of what attributes signal the desired experiences. In other words, what about a product provides the desired experience to a consumer? Once these steps are performed and an understanding of behaviors, desired experiences and the attributes that provide those experiences, a framework can be built that enables researchers to understand how a product or service may result in the experiences desired by consumers 308. Once this step is complete, research may be conducted 310 to further refine how a consumer of the product or service perceives the product and how that perception results in the desired emotions or experiences.

FIG. 3 illustrates a diagram with the high-level steps performed in order to prompt and capture feedback from participants regarding the product features being examined. These steps identify the participant's perceptions of an ideal product and works through a process of steps designed to understand what triggers these perceptions. The steps in the process result in an ideal experience framework which can be used to identify desires and high level benefits and features that support the desired experience.

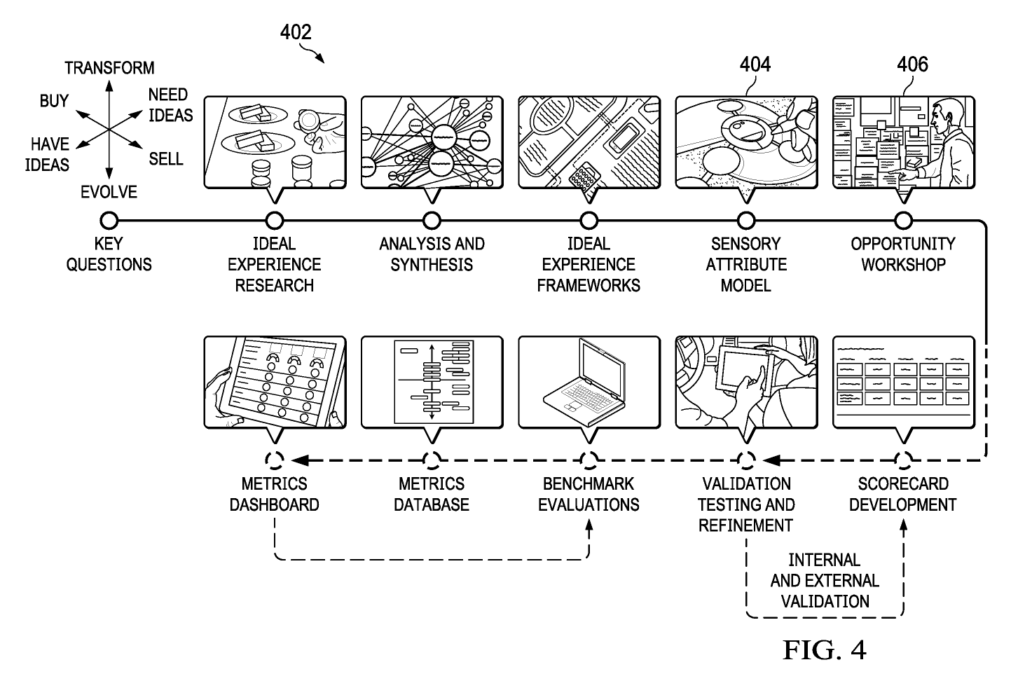

FIG. 4 illustrates a graphical representation of both a framework development portion 402 and also the application of that framework to create a sensory attribute model 404 which is applied to research conducted in an opportunity workshop.

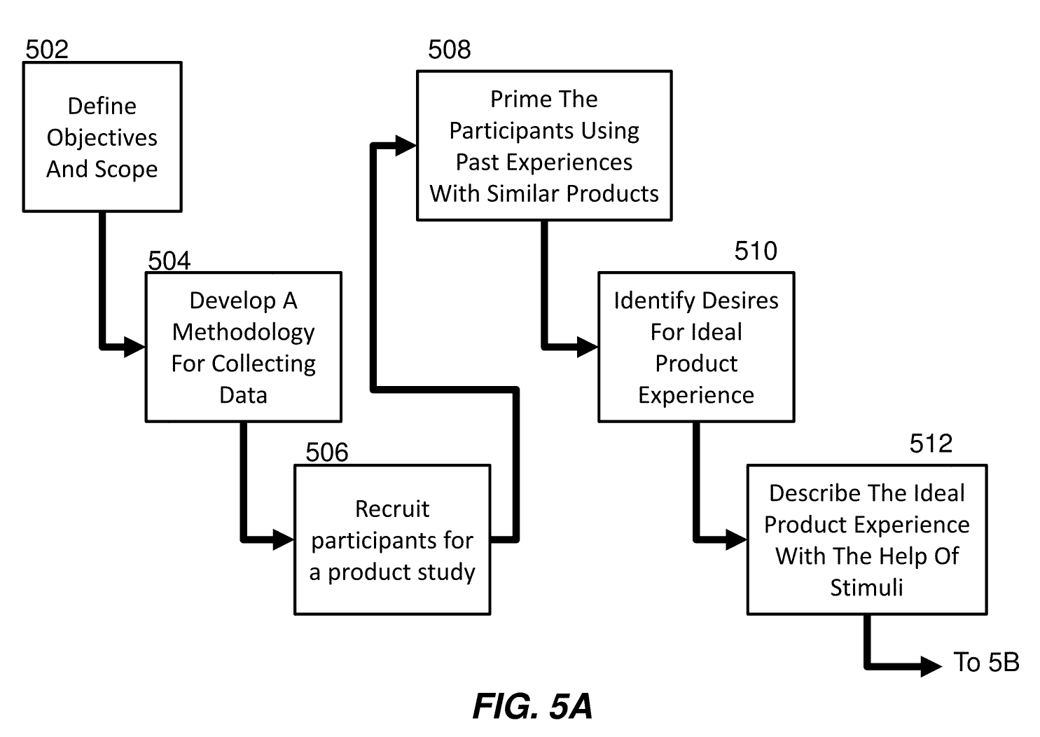

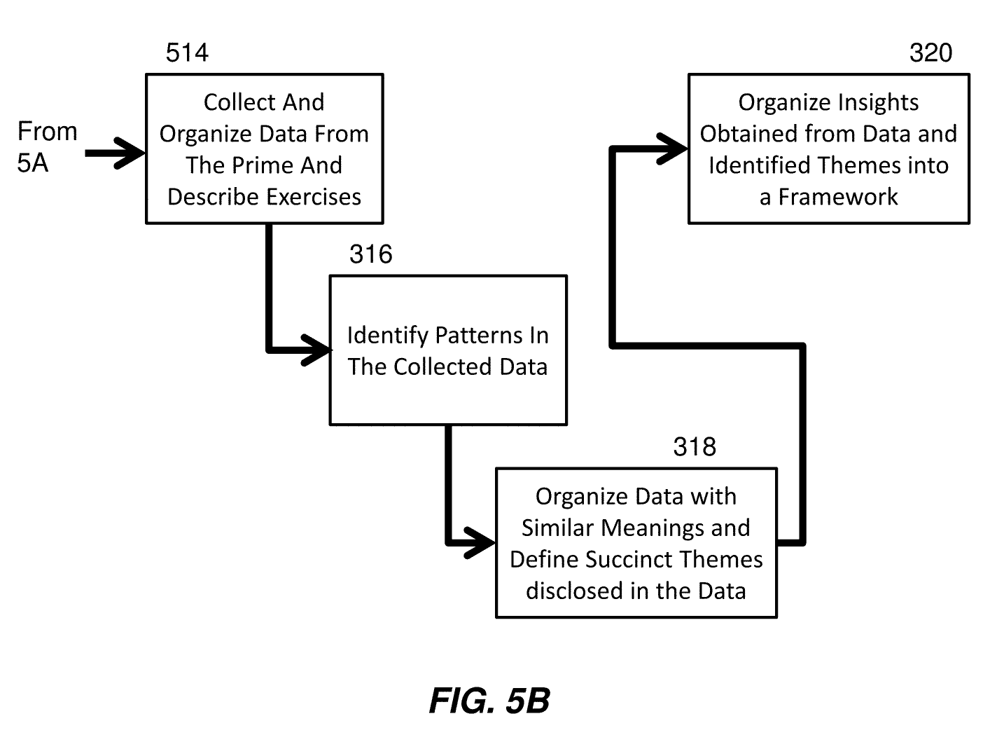

Referring to FIGS. 5A and 5B, step 502 is the definition of the objectives and scope of a particular framework generation. This step serves to identify the subject and set limits on the scope of the research. In an example embodiment, a user's experience with regard to certain product features and interface characteristics may be evaluated. For purposes of explanation, the product may be an automobile. The definition of objectives may begin with the definition of a desired driving experience (emotion) that results from these features and characteristics. Thus, the objective may be to determine what emotion that a user wishes to feel when using the product. Alternatively, the sponsor of the research may define the attributes that they wish to explore. The definition step also includes the identification of project scope. The project scope may be very broad and include all product features or characteristics. Conversely, the project scope may be narrowly tailored to focus on a specific feature of the invention. Scope can be defined because the sponsor of the project wishes to precisely target a specific project characteristic or feature, or the sponsor may wish to control the time or cost involved in such a study. For example, in an embodiment of the inventive process, it may be decided that the scope of the research should be limited to a user's interaction with certain vehicle dashboard controls, such as sound, climate, and navigation controls. This scope may be further refined as part of an iterative process that results from the identification of features and characteristics that are more critical to a user's perception of a product or service. For example, the scope of a framework generation process may initially comprise the entire vehicle dashboard but be redefined to focus on only a portion of the dashboard such as the audio system. The scope can be further redefined such that it may be narrowed to such things as the way a particular control is arranged or operated. This step may also comprise the identification of what sort of documentation is required to support an organization's use of the generated framework.

As is illustrated at 504, the next step may be the development of a methodology for collecting data regarding the product or service features and benefits. This methodology may include the identification of research activities and the development of a set of associated tools for such research. The methodology must be repeatable and scalable such that it may be applied to various groups of potential or actual product users with consistent results. In addition to tools, the methodology may comprise projective exercises and multi-sensory stimulus where these components may be applied in order to provide a complete understanding of a program participant's current and ideal experience with regard to a product or service.

As the method of generating an ideal experience framework features interviews with various persons, step 506 includes the recruitment of these persons. Depending upon the project objectives defined in step 502, persons to be interviewed may be located in various markets in a particular territory. Alternatively, those interviewees may be selected based on considerations such as income level, past product ownership or use or other characteristics related to the product or competing products. Selecting more than one market from which to recruit interviewed persons may provide a broad insight into the potential users of the product or service. For example, interviewed persons may be recruited from a particular geographic area if the product or service is geographically limited with regard to potential customers. Conversely, should a product or service be available to a larger geographic area, recruitment may be conducted in a number of representative markets. A screening algorithm may be applied to potential participants where the screening algorithm may comprise a series of additional criteria to ensure that the participants include a mix of generations, demographics, product ownership, or attitudes with regard to how a product is used or performs.

In step 508, those participants selected in step 506 are immersed in their past and present experiences with the products or service type. This step may generate an increased awareness of the product or service such that the user becomes more aware of and thus better able to communicate their feelings with regard to a product or service. Thus, this step may serve to enable the user to more clearly identify and articulate their desired product or service experiences. This immersion process may comprise pre-interview activities and tasks such as journaling and product experience timeline maps. In many instances, the actual content of the journals and timeline maps are less important than the process of a user considering these thoughts and experiences however, these written materials may still be collected as part of the data entry process in step 514.

The next phase of the process involves interviews of various participants to gather data with regard to their ideal product experience. The interview process may comprise two phases. As indicated in step 510, the first phase of the interview process may focus on the exploration of an interviewee's desires for the future with regard to the product or service which is the subject of the research process. This first phase may use projective stimuli and sequential interview progression in order to facilitate a participant's transition into an aspirational mindset where the participant is able to identify desires for their ideal experience with regard to the product or service. Projective stimuli may include words, images, items or scents that provoke thoughts of an ideal product or service experience. Projective stimuli may assist a panel member to express their feelings with regard to a desired product experience. An example of projective stimuli used for purposes other than identifying a panelist's desires with regard to a product is the Rorschach inkblot test. As with that tool, the projective stimulus is concerned not with the stimulus but with the way the subject responds to the stimulus. However, in the present invention, the stimuli are used to provide a framework for responding to a product's characteristics and features.

In the second part of the interview process 512, participants are again provided projective stimuli and prompted to use the stimuli to develop an expression of the ideal product or service experience with regard to the defined scope of the research. For example, if a participant indicates that a product control should feel “precise”, they are prompted to identify stimuli that express that feeling. As this second part of the interview process continues, the participant is asked to describe why a projective stimulus evoked a particular feeling with regard to the product. In particular, a researcher may ask a participant why they picked the particular stimulus. A participant may indicate that a stimulus object has a control function that evokes a feeling of preciseness. The interviewer may then ask the participant to further describe the feeling with regard to the particular feature of the stimulus object. This process continues until all projective stimuli have been reviewed. The result is a narrative of the participant's ideal experience using words that relate to the projective stimulus objects. The words used in this narrative are recorded. The feelings with regard to the stimuli are less important than how those feelings are expressed. For example, if a stimulus object has a dark surface, the user may indicate that the object may be easy to clean because it doesn't show fingerprints. The participant is expressing the benefit “easy to clean” by describing the stimulus object. Thus, the identification and collection of words used by participants to describe the stimulus object with regard to a product benefit are the key pieces of information sought in this step.

In step 514, the narratives from a plurality of participants are collected and entered into a database. This step may also include the entry of participant experience timeline maps and journal entries from step 508. The entered information generally comprises the expressions used by the participants to describe their ideal experience. The information also includes how the stimulus objects are described with regard to the attribute that they represent to the participant. Once this information is captured and recorded in a database, the database entries are normalized and assigned codes.

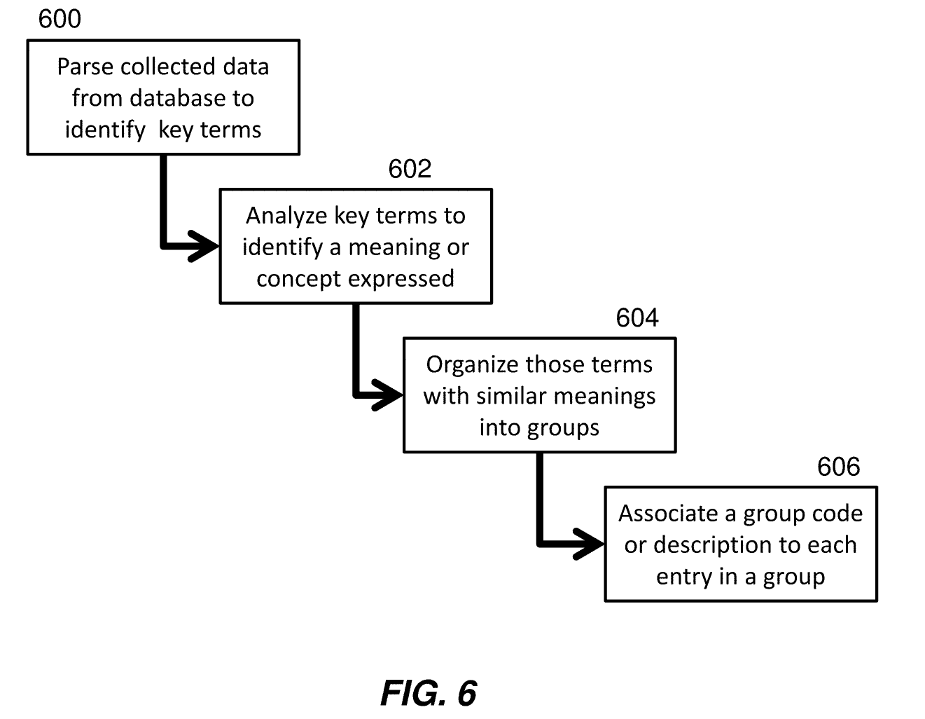

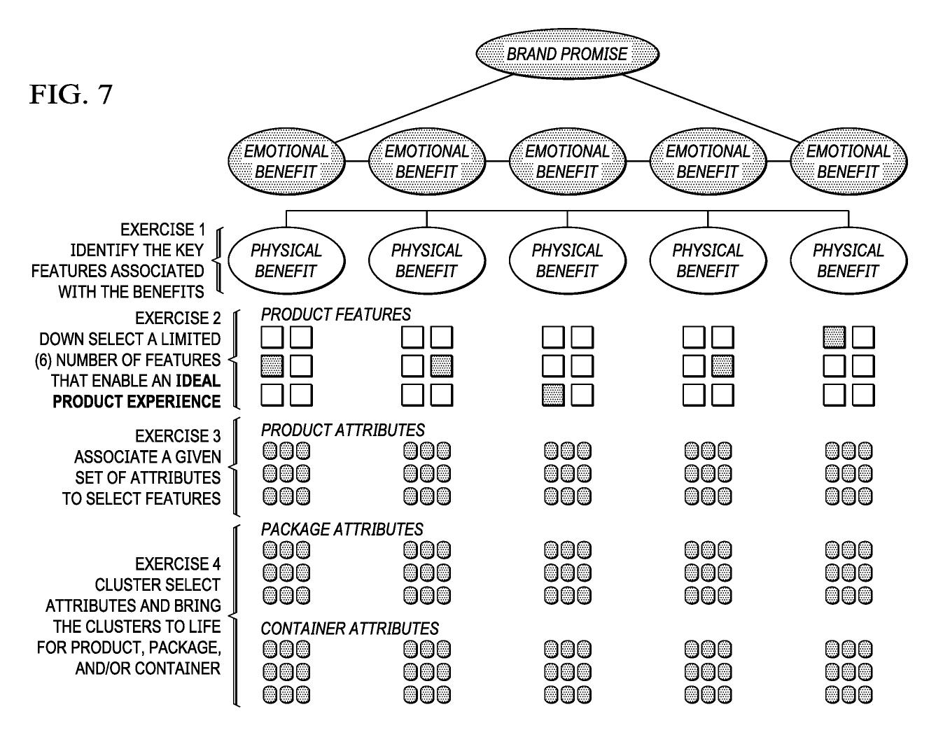

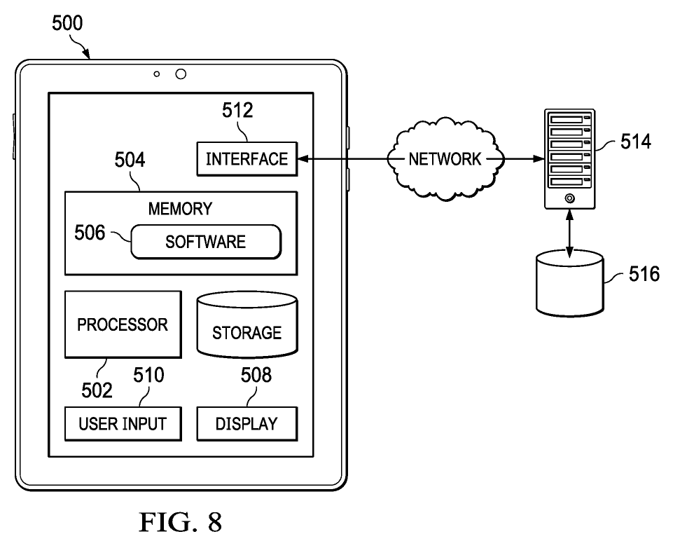

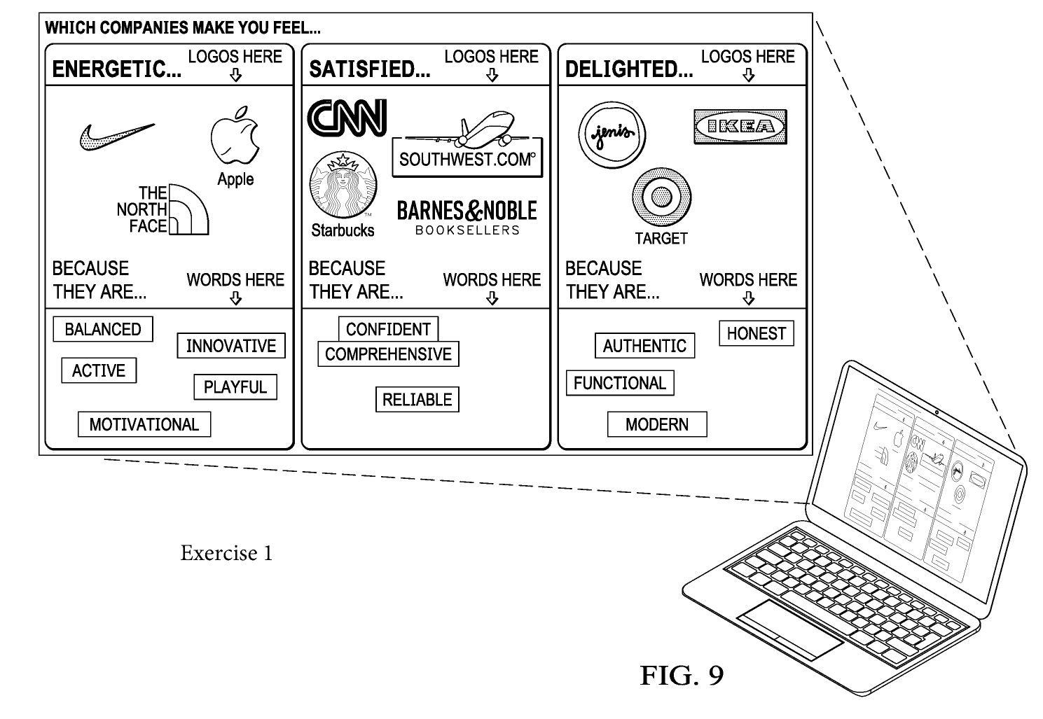

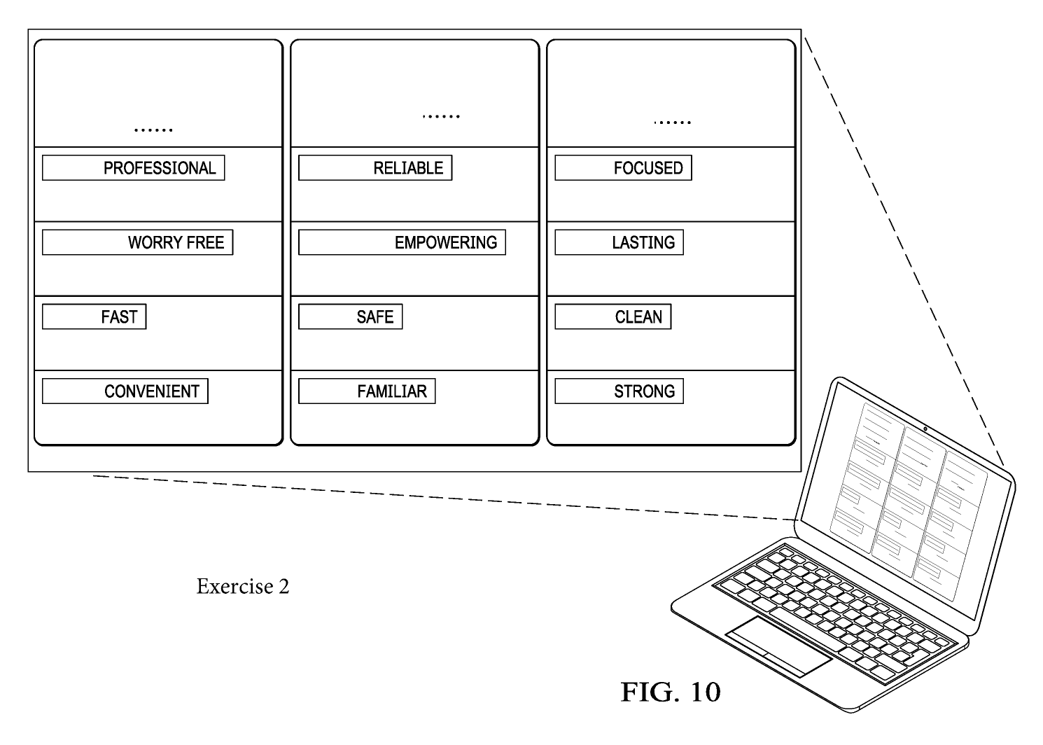

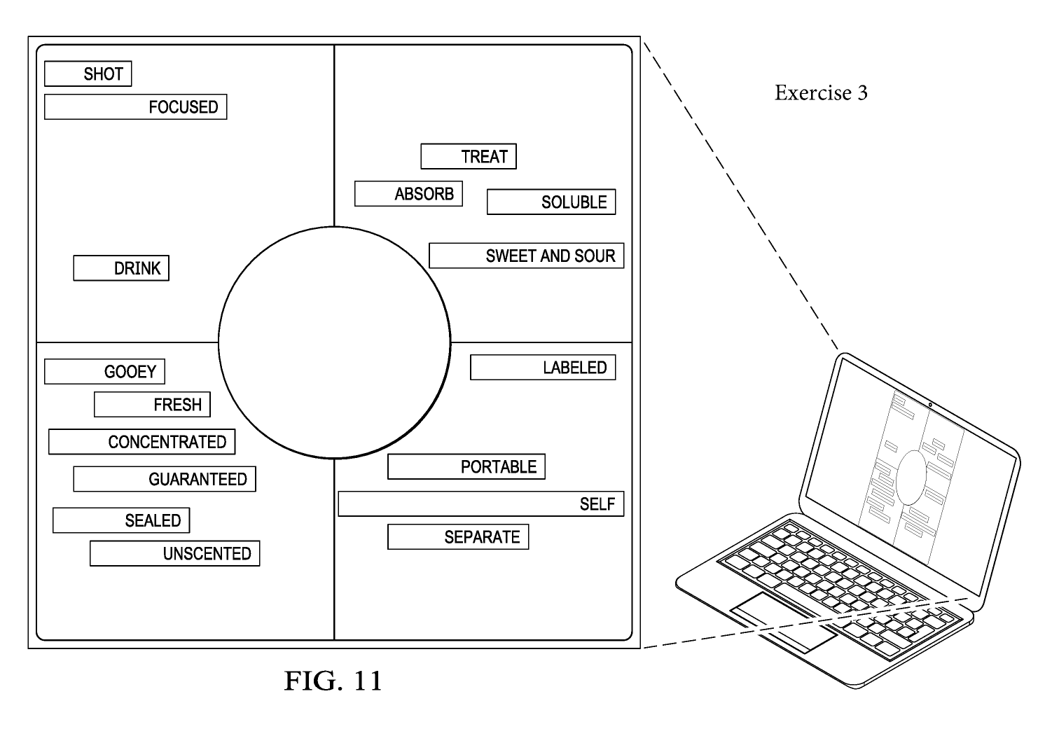

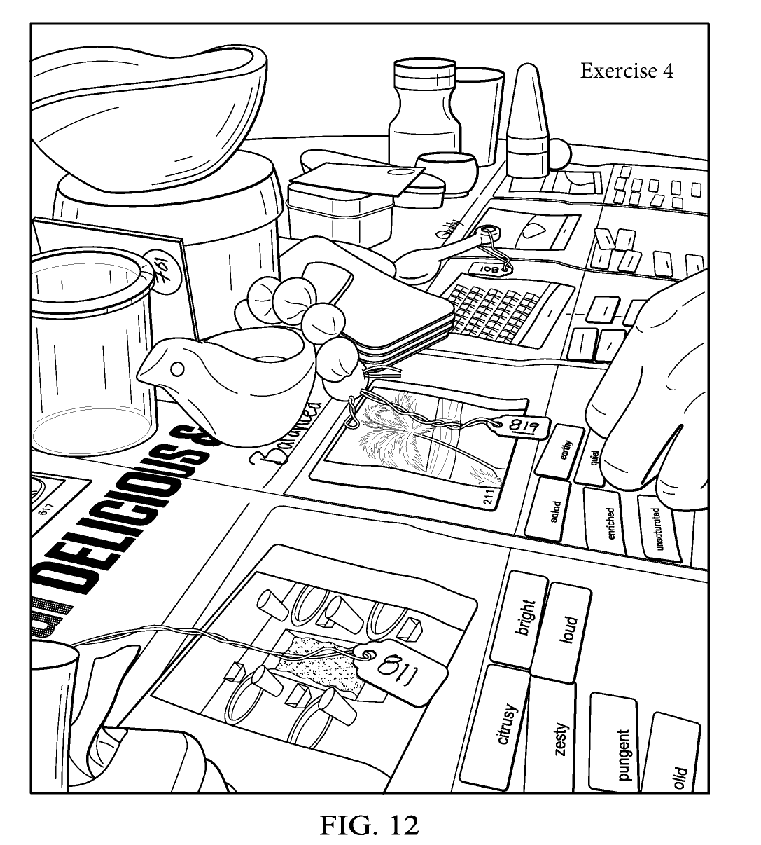

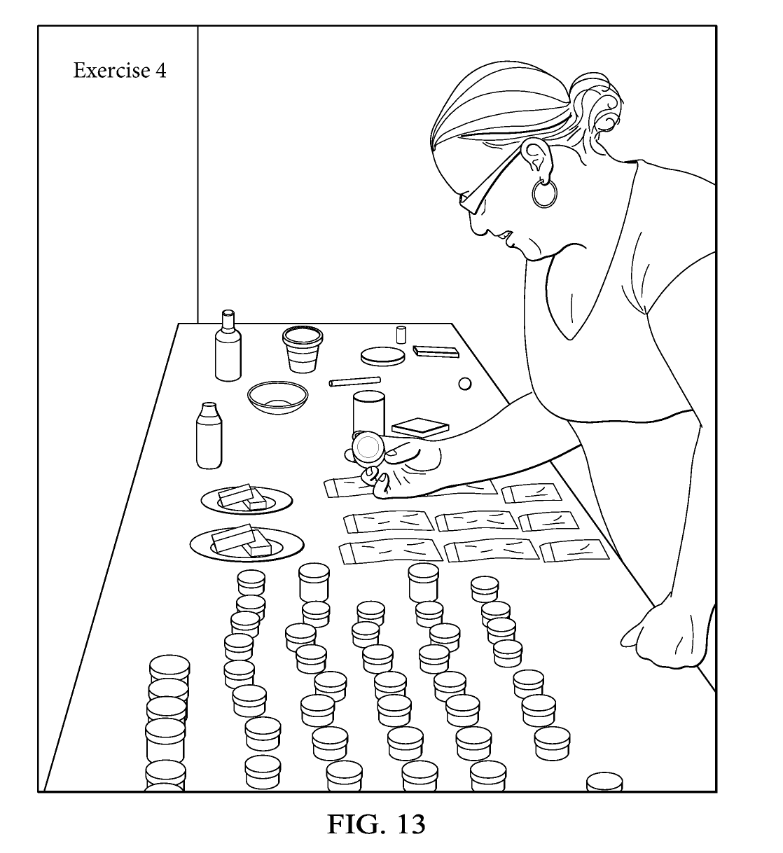

A high-level summary of the steps of this normalization process are illustrated in FIG. 6. In step 600, database entries are parsed to identify the primary terms in each response. In step 602, these primary terms are analyzed to identify their core meaning and then to identify other entries with similar meanings. The entries are organized into groups according to their meaning 604 and an identifying code or description is associated with each entry 606. This normalization process facilitates a review of entries by highlighting groups of entries that, while they may use different terms to describe a feeling, are similar in their conveyed meaning.

In step 516 of FIGS. 5A and 5B, the normalized database entries are systematically analyzed to identify patterns in the participant data. The analysis may be conducted by applying tools such as affinity diagrams, co-occurrence models and frequency counts. For example, an analysis of the entered data may reveal a recurring reference to an attribute such as durability. This recurrence may indicate that the participants consider this to be an important attribute for products of the type being analyzed. One of ordinary skill in the art will understand that other pattern recognition techniques may be applied without deviating from the spirit of the invention.

Once participant response patterns are identified, the patterns are made available for further review by researchers in step 518. In addition to the identified patterns, the raw response data may also be presented to assist reviewers in understanding the relationships between the data and the identified patterns. The information may be further organized to further group together data with similar meanings. Reviewers may then analyze the available data in order to define succinct themes. These themes are then further consolidated into meta-themes. Reviewers then prioritize key insights and identify strengths, weaknesses, gaps and opportunities that are disclosed by the organized data.

In step 520, the themes and identified relationships are translated into an insight framework. Such frameworks are organized into a single visual diagram that permits the sponsor of the research to quickly identify the key themes and key terms used to describe those themes. An example of such a diagram is illustrated in FIG. 2. As is shown, the key emotional benefits are illustrated at 402. The themes associated with those benefits are shown at 204 and the main terms used to describe those themes are shown at 206. In some circumstances, the themes may overlap such that the benefits may have some themes and terms that are common to both. Other means of presenting the result of the previously described analysis may be the creation of process flow diagrams, storyboards, or other narratives, which represent the relationships between the themes. The framework may include expressed desires and high-level benefits and features that support the desired experience.

As part of step 518, the identified themes may be further examined to identify any further relationships among the themes. These may include hierarchy or causality relationships between related themes. These relationships may be indicated in the insight framework diagram.

The researchers may further analyze the framework diagram and data in order to generate consumer-centric ideas that support the ideal experience disclosed by the insight framework. An opportunity workshop is conducted in step 522 in order to map these generated ideas against parameters that define the sponsoring organization's innovation strategy. An example of this may be an opportunity for the sponsor to review the required investment required to revise a product to add certain cues verses the impact to an organization that may result from that investment or the lack of those cues in the product.

In step 524, the ideas generated as the result of the previous steps are assessed in order to identify areas of interest to the organization. Key benefits can be selected for further study. Once these key benefits have been identified, associated attributes can also be identified. A follow-up study can be conducted to discover additional data, which allows these attributes to be described in greater detail.

Steps 502 to 522 can be repeated with a focus strictly on those attributes identified and described in step 524. The result of this second study should be narrowly focused on the key benefits and features related to the identified attributes. A wide variety of multi-sensory stimuli (such as words, images, abstract objects, textures, smells and sounds) may be employed. As with the previous study, these stimuli may assist participants in the second study such that they are able to express key benefits and features. As with the first study, automated analysis of the participant expressions of these features, such that patterns may be identified, is used to express the ideal product or service experience expressed by a plurality of panelists, and a report is generated which reveals the framework.

As shown at step 526, once the ideal experience has been defined, product or service concepts can be evaluated using the ideal experience as a framework upon which to structure the concept evaluation. As shown in FIG. 2 the system of the present invention processes the collected data to create a framework as illustrated in FIG. 2 and FIG. 4 to conduct an opportunity workshop 406 and also to develop a scorecard for use in a benchmark evaluation process which may be used to rank the emotional response that results from the sensory cues associated with the product or service.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A system for constructing a framework of features for product or service optimization, said system comprising:
a. Identification of a subject to optimize;
b. Identification of at least one feature of said subject for analysis;
c. Identification of at least one objective for said subject;
d. Presentation of external, tangible stimuli, said external tangible stimuli external to and apart from said subject and said at least one feature, to collect and store consumer expressions associated with said at least one objective and said at least one feature, in a database;
e. Computerized analysis of said expressions to identify patterns of themes in said collected expressions; and, f. Applying a data normalizing technique through a computer processor, to said patterns of themes to produce an insight framework diagram of data adapted to improve said subject relative to said objective.

2. A system for establishing an improved product framework comprising:
a defined objective;
a pool of participants for qualitative feedback;
a priming stimulus to engage said participants;
an analysis of said feedback to identify patterns or themes;
a categorizing of said patterns or themes as an emotion, benefit, feature, or attribute; and
developing directed questions to said emotions, benefits, features, and attributes for use in comparing products and prototypes.
